(19) United States
(12) Patent Application Publication
(10) Pub. No.: US 2025/0271942 A1
(43) Pub. Date: Aug. 28, 2025

(54) System and Method for Generating and Transmitting Single-Use Tokens Based on Multidimensional Captures of Digital Signature Gestures

(71) Applicant: Bank of America Corporation, Charlotte, NC (US)

(72) Inventors: Pushkar Taneja, Hyderabad (IN); Sushama Shelke, Mumbai (IN); Durga Prasad Kutthumolu, Hyderabad (IN); Shailendra Singh, Maharashtra (IN)

(21) Appl. No.: 18/587,158

(22) Filed: Feb. 26, 2024

(51) Int. Cl. G06F 3/01; G06T 19/00; H04L 9/32

(52) U.S. Cl. CPC G06F 3/017; G06T 19/006; H04L 9/3228; H04L 9/3247

(57) ABSTRACT

A method includes rendering, on one or more displays of an extended reality (XR) device, an XR environment. The XR environment is configured to facilitate user interactions with a plurality of XR applications while executing within the XR environment. The method includes detecting, based on sensor data obtained from sensors of the XR device, a user gesture performed in three-dimensional (3D) space. The detected user gesture includes a point cloud representative of user interactions performed in 3D space. The method includes determining, based on the detected user gesture, a unique digital signature of the user in 3D space, generating, based on the unique digital signature of the user, a single-use interaction token for finalizing an execution of a sequence of user interactions with an XR application, and finalizing the execution of the sequence of user interactions with the XR application based on the single-use interaction token.

### TECHNICAL FIELD

The present disclosure relates generally to digital signature gestures, and, more specifically, to a system and method for generating and transmitting single-use tokens based on multidimensional captures of digital signature gestures.

### BACKGROUND

Some institutions may provide applications suitable for extended reality (XR) environments (e.g., virtual-reality (VR) environments, augmented-reality (AR) environments, mixed-reality (MR) environments, and so forth), which may allow users to perform interactions in XR. As the number of users and associated user avatars interacting with such applications increases, users may perform sensitive user interactions and exchange sensitive data within XR environments. However, many existing XR security processes rely primarily on the service executing and hosting an XR environment, and thus securing particular applications executing within the XR environment and the user interactions therewith may be impeded.

### SUMMARY

The system and methods implemented by the system as disclosed in the present disclosure provide technical solutions to the technical problems discussed above by providing systems and methods for generating and transmitting single-use tokens based on multidimensional captures of digital signature gestures. The disclosed system and methods provide several practical applications and technical advantages.

Specifically, in accordance with the presently disclosed embodiments, one or more processors of a system may receive from one or more LiDAR sensors of an extended reality (XR) device a capture of a unique digital signature gesture of a user performed in three-dimensional (3D) physical space. For example, the user may perform the unique digital signature gesture in 3D space while viewing an XR environment executing on the XR device. The one or more processors may then convert the LiDAR sensor capture of the unique digital signature gesture into a 3D point cloud, which may represent a feature vector of the unique digital signature gesture of the user in 3D space.

The one or more processors may then utilize the feature vector to generate a single-use interaction token for the user to execute a specific interaction with an XR application executing within the XR environment. For example, in one embodiment, the one or more processors may generate the single-use interaction token for the user to finalize an execution of a sequence of user interactions with the XR application executing within the XR environment. In one embodiment, the generated single-use interaction token may include an encryption of the digital signature gesture to be utilized to finalize the execution of the sequence of user interactions with the XR application. Upon completion of the execution of the sequence of user interactions with the XR application, the one or more processors may then destroy the single-use interaction token.

Thus, the disclosed system and methods improve XR systems by providing a 3D token-based authentication process specifically suited for XR environments to secure sensitive data and user interactions exchanged and/or executed within XR environments. Specifically, in response to a user attempting to finalize the execution of a sequence of user interactions with an XR application executing within the XR environment, the user is prompted to perform a unique digital signature gesture. The unique digital signature gesture is converted to a 3D point cloud and utilized to generate a unique single-use interaction token for the user. The user is then allowed to finalize the execution of the sequence of user interactions with the XR application based on the unique single-use interaction token, which is then destroyed.

In this way, the disclosed system and methods further improve XR environments and data transmission security associated with XR environments, as the unique single-use interaction token is an encrypted and use-and-destroy 3D digital token incapable of being replicated, modified, reused, or stored for more than a few minutes (e.g., less than 5 minutes, less than 3 minutes, or less than 1 minute). Additionally, the 3D nature of the unique single-use interaction token provides a further layer of security by leveraging the uniqueness of each individual user and the various hand, head, and body poses performable by individual users in 3D physical space.

In particular embodiments, one or more processors of a system may render, on one or more displays of an extended reality (XR) device, an XR environment. For example, in one embodiment, the XR environment may be configured to facilitate user interactions with a plurality of XR applications while executing within the XR environment. In particular embodiments, the one or more processors may then detect, based on sensor data obtained from one or more sensors of the XR device, a user gesture performed in three-dimensional (3D) space. For example, in one embodiment, the detected user gesture may include a point cloud representative of one or more user interactions performed in 3D space.

In particular embodiments, the one or more sensors of the XR device may include one or more Light Detection and Ranging (LiDAR) sensors or one or more depth cameras. In particular embodiments, the one or more processors may then determine, based on the detected user gesture, a unique digital signature of the user in 3D space. In particular embodiments, the one or more processors may then generate, based on the unique digital signature of the user, a single-use interaction token for finalizing an execution of a sequence of user interactions with at least one of the plurality of XR applications. In particular embodiments, the one or more processors may then finalize the execution of the sequence of user interactions with the at least one of the plurality of XR applications based on the single-use interaction token.

For example, in particular embodiments, the one or more processors may finalize the execution of the sequence of user interactions with the at least one of the plurality of XR applications to execute a predetermined action. In particular embodiments, the one or more processors may encrypt the single-use interaction token with the unique digital signature of the user utilizing a 3D discrete wavelet transform (DWT). In particular embodiments, the one or more processors may destroy the single-use interaction token subsequent to the execution of the sequence of user interactions with the at least one of the plurality of XR applications. In particular embodiments, the single-use interaction token may be configured to be modulated into a plurality of optical bits utilizing a radiant crystal waveguide. For example, in particular embodiments, the plurality of optical bits may be configured to be transmitted utilizing steganography and wavelength division multiplexing (WDM) based fiber optical communication.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a system of an extended reality (XR) system and network, in accordance with certain aspects of the present disclosure;

FIG. 2 is a block diagram of an embodiment of a workflow for generating and transmitting single-use tokens based on multidimensional captures of digital signature gestures, in accordance with certain aspects of the present disclosure;

FIG. 3 illustrates a flowchart of an example method for generating and transmitting single-use tokens based on multidimensional captures of digital signature gestures, in accordance with one or more embodiments of the present disclosure.

### DETAILED DESCRIPTION

### Example System

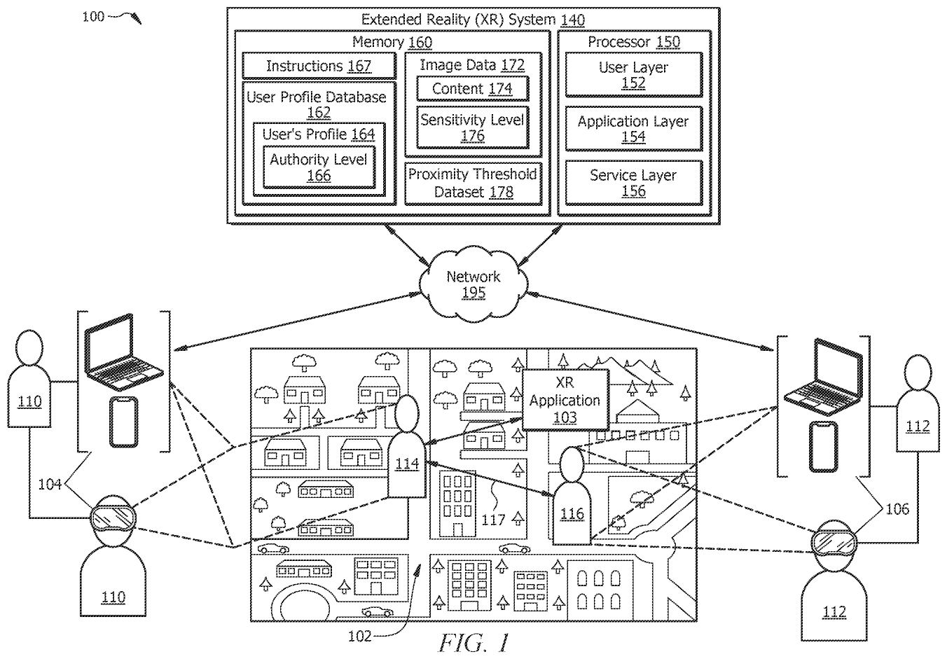

FIG. 1 is a block diagram of an extended reality (XR) system and network 100, in accordance with certain aspects of the present disclosure. In particular embodiments, the system and network 100 may include a first XR device 104, a second XR device 106, real-world server 130, and a XR system 140, each connected to a network 195. A first user 110 is associated with the first XR device 104 and a second user 112 is associated with the second XR device 106. The system and network 100 may be communicatively coupled to the network 195 and may be operable to transmit data between each one of the first XR device 104, the second XR device 106, and the XR system 140 through the network 195.

The system and network 100 may improve interoperability and security of extended reality (XR) systems (e.g., virtual reality (VR) systems, augmented reality (AR) systems, mixed (MR) systems, and so forth) so that information may be seamlessly and securely shared between these systems to implement data security, authorization and authentication of data interactions, access to an extended reality environment 102 (e.g., metaverse environment, VR environment, AR environment, MR environment, or some combination thereof), access to entities within the extended reality environment 102 and other data interactions performed in real-world and extended reality environments. For example, user information or sensor data retrieved from a user and/or a user's XR device in a real-world environment may be used in the extended reality environment 102 to determine whether to restrict or allow access to a particular XR application 103 or one or more particular rendered objects associated with the particular XR application 103 within the extended reality environment 102 and/or to perform any kind of action or interaction with the particular XR application 103 or the one or more particular rendered objects associated with the particular XR application 103.

Additionally, or alternatively, user information collected from the first user 110 and/or assigned to the first user 110 in the real-world environment or extended reality environment 102 may be used in the extended reality environment 102 to provide the first user 110 access to products, services and/or experiences within the extended reality environment 102. The system 140 improve XR systems by providing a three-dimensional (3D) token-based authentication process specifically suited for the XR environment 102 to secure sensitive data and user interactions exchanged and/or executed within the XR environment 102. Specifically, in response to the first user 110 attempting to finalize the execution of a sequence of user interactions with the XR application 103 executing within the XR environment 102, the first user 110 is prompted to perform a unique digital signature gesture. The unique digital signature gesture is converted to a 3D point cloud and utilized to generate a unique single-use interaction token for the first user 110. The first user 110 is then allowed to finalize the execution of the sequence of user interactions with the XR application 103 based on the unique single-use interaction token, which is subsequently destroyed.

In this way, the disclosed system 140 further improve the XR environment 102 and data transmission security associated with the XR environment 102, as the unique single-use interaction token is an encrypted and use-and-destroy 3D digital token incapable of being replicated, modified, reused, or stored for more than a few minutes (e.g., less than 5 minutes, less than 3 minutes, or less than 1 minute). Additionally, the 3D nature of the unique single-use interaction token provides a further layer of security by leveraging the uniqueness of each individual user 110, 112 and the various hand, head, and body poses performable by individual users 110, 112 in 3D physical space.

In particular embodiments, the first user 110 may access the extended reality environment 102 through the first XR device 104. The first XR device 104 is configured to display a two-dimensional (2D) or three-dimensional (3D) representation of the extended reality environment 102 to the first user 110. Examples of an extended reality environment 102 may include, but are not limited to, a graphical or virtual representation of a metaverse, a map, a building interior, a landscape, a fictional location, an alternate reality, or any other suitable type of location or environment. The extended reality environment 102 may be configured to use realistic or non-realistic physics for the motion of objects and allow the avatars 114, 116 to interact with one or more XR applications 103 within the extended reality environment 102. For example, some extended reality environments 102 may be configured to use gravity whereas other extended reality environments 102 may not be configured to use gravity. Within the extended reality environment 102, each user may be associated with an avatar (such as the first avatar 114 for the first user 110). An avatar is a graphical representation of a user at a virtual location within the extended reality environment 102.

The virtual location of each avatar 114, 116 may be correlated to the physical location of each respective user 110, 112 in the real-world environment. Examples of avatars 114, 116 may include, but are not limited to, a person, an animal, or an object. In some embodiments, the features and characteristics of the avatars 114, 116 may be customizable, and user defined. For example, the size, shape, color, attire, accessories, or any other suitable type of appearance features may be specified by a user. By using the avatars 114, 116, the respective users 110, 112 may be able to move within the extended reality environment 102 to interact with one or more avatars and objects within the extended reality environment 102 while independently remaining at a physical location in the real-world environment or being in transit in the real-world environment.

While engaging in the extended reality environment 102 via the first avatar 114, the first user 110 may interact with a number of other users, objects and/or entities through a respective avatar. For example, the second user 112 may attempt to engage in an interaction session with the first avatar 114 through a second avatar 116 associated with the second user 112. In another example, the first avatar 114 of the first user 110 may access an extended reality sub-environment (not shown) within the extended reality environment 102 and perform virtual data interactions within the virtual sub-environment. In the real-world environment, the second user 112 may be physically located at a distance away from the first user 110. The second user 112 may access the extended reality environment 102 through the second XR device 106 to control the second avatar 116 and attempt to engage in an interaction session with the first user 110 through the first avatar 114.

Before the interaction between the first avatar 114 and the second avatar 116 occurs, the XR system 140 may authenticate that the first avatar 114 is associated with the first user 110 and not an unauthorized third-party. For example, the first user 110 may be required to sign into a secure portal that provides access to a data file associated with the first user 110. In some examples, a real-world data file of the first user 110 and a first virtual data file of the first user 110 may be stored and managed by the XR system 140. Similarly, a second virtual data file associated with the second user 112 is managed by the XR system 140.

The XR system 140 may store other information related to the first user 110 including, but not limited to, users' profile 162, account information (e.g., including identity and other details relating to users 110, 112), avatar information, digital assets information, or any other suitable type of information that is associated with a user within the extended reality environment 102 and/or the real-world environment. As depicted in FIG. 1, the XR system 140 may include a processor 150 and a memory 160. The processor 150 may include one or more processors operably coupled to the memory 160. In some embodiments, the processor 150 may be any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). In other embodiments, the processor 150 may be a programmable logic device, a microcontroller, a microprocessor, or any suitable combination of the preceding.

The processor 150 is communicatively coupled to and in signal communication with the memory 160. The processor 150 may be configured to process data and may be implemented in hardware or software. For example, the processor 150 may be 8-bit, 16-bit, 32-bit, 64-bit or of any other suitable architecture. The processor 150 may include an arithmetic logic unit (ALU) for performing arithmetic and logic operations, processor registers that supply operands to the ALU and store the results of ALU operations, and a control unit that fetches instructions 167 from memory 160 and executes them by directing the coordinated operations of the ALU, registers and other components.

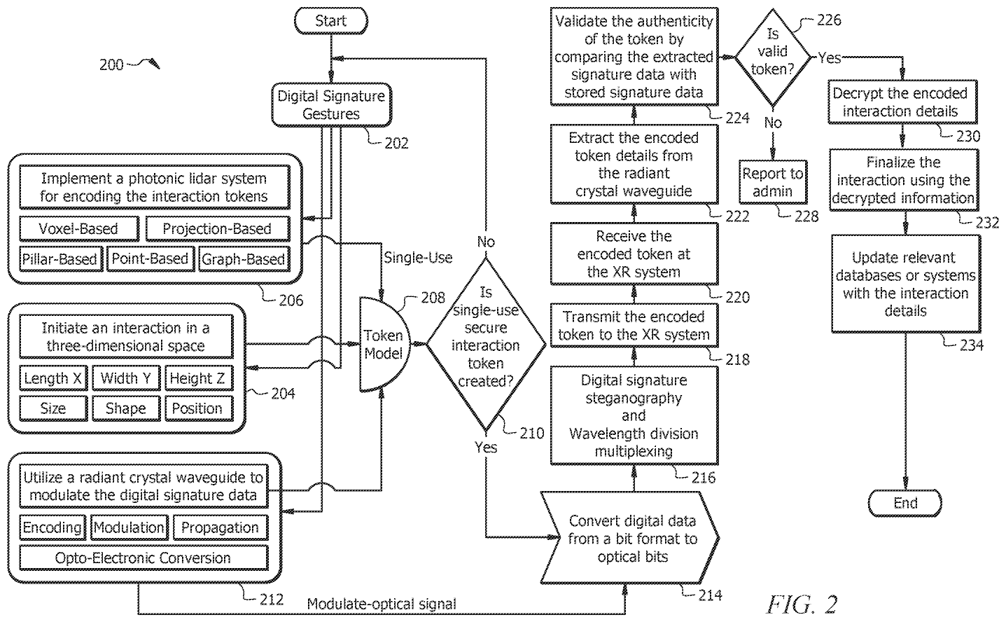

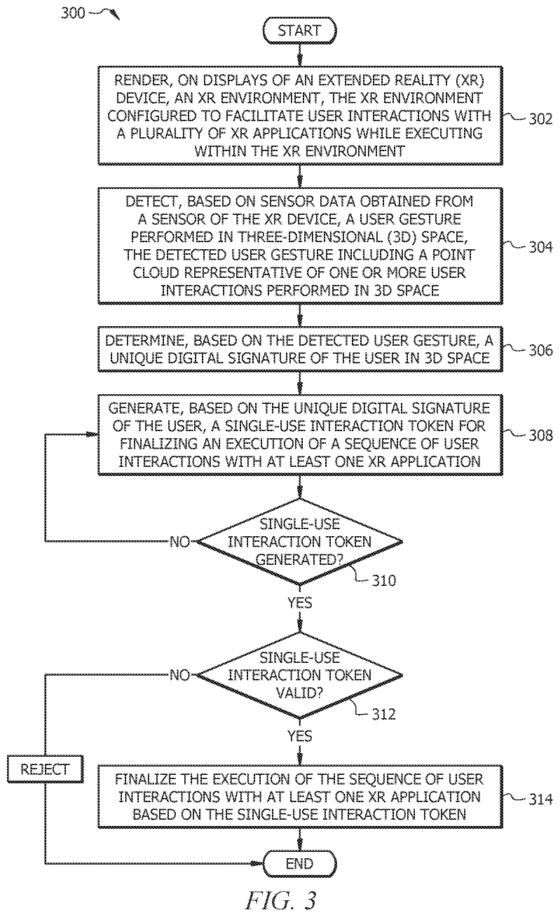

The processor 150 may be configured to implement various instructions 167. For example, the processor 150 may be configured to execute the instructions 167 to implement the XR system 140. In this way, processor 150 may be a special-purpose computer designed to implement the functions disclosed herein. In particular embodiments, the XR system 140 is implemented using logic units, FPGAs, ASICS, DSPs, or any other suitable hardware. The XR system 140 is configured to operate as described below with reference to FIGS. 2 and 3, for example. For example, the processor 150 may be configured to perform at least a portion of the method 300 as described in FIG. 3. In particular embodiments, as will be discussed in greater detail below, the processor 150 may include a user layer 152, an application layer 154, and an XR service layer 156.

The memory 160 may include one or more disks, tape drives, or solid-state drives, and may be used as an over-flow data storage device, to store programs when such programs are selected for execution, and to store instructions 167 and data that are read during program execution. The memory 160 may be volatile or non-volatile and may comprise a read-only memory (ROM), random-access memory (RAM), ternary content-addressable memory (TCAM), dynamic random-access memory (DRAM), and static random-access memory (SRAM). The memory 160 may include any non-transitory computer-readable medium. In particular embodiments, the memory 160 is operable to store users' profiles 162, a first user's profile 164, an authority level 166, image data 172, content 174, a sensitivity level 176, and a proximity threshold dataset 178. In particular embodiments, the image data 172 may include any pixel data or voxel data that may be utilized to render and display the extended reality environment 102 (including XR application 103 and avatars 114, 116) onto respective displays of the XR devices 104 and 106 of the first user 110 and the second user 112, respectively.

The network 195 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WI Gig, WiMAX, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network, operable to facilitate communication between the components of system and network 100. In other embodiments, system and network 100 may not have all of these components and/or may have other elements instead of, or in addition to, those above.

While the present embodiments may be discussed herein primarily with respect to XR devices 104, 106 being suitable for rendering and displaying the extended reality environment 102 (including XR application 103 and avatars 114, 116), it should be appreciated that the XR devices 104, 106 may be any user computing devices configured to communicate with other devices, such as a server (e.g., XR system 140), databases, etc. through the network 195. Each of the user devices may be configured to perform specific functions described herein and interact with the XR system 140, e.g., via respective user interfaces. Each of the XR devices 104, 106 is a hardware device that is generally configured to provide hardware and software resources to the first user 110 and the second user 112, respectively.

Examples of the XR devices 104, 106 include, but are not limited to, a VR device, an AR device, an MR device, a laptop, a computer, a smartphone, a tablet, a smart device, an Internet-of-Things (IoT) device, or some combination thereof. In particular embodiments, the XR devices 104, 106 may each include one or more displays, a touchscreen, a touchpad, keys, buttons, a mouse, or any other suitable type of hardware that allows the respective users 110, 112 to view data and/or to provide inputs into the XR devices 104, 106. In particular embodiments, the XR devices 104, 106 may also each include any number of sensors suitable for detecting and tracking sensor data (e.g., telemetry data) associated with one or more of the XR devices 104, 106, the users 110, 112, the avatars 114, 116, and/or the one or more XR applications 103.

For example, in particular embodiments, the number of sensors may include one or more of Light Detection and Ranging (LiDAR) sensors (e.g., LiDAR scanner), inertial measurement units (IMUs), one or more monochromatic cameras, one or more visible-light cameras (VLCs), one or more infrared (IR) cameras, one or more depth cameras, one or more accelerometers, one or more magnetometers, one or more gyroscopes, or other sensors that may be suitable for detecting and tracking a 3D head pose of the respective users 110, 112, an 3D eye gaze of the respective users 110, 112, a 3D hand gesture of the respective users 110, 112, a 3D face of the respective users 110, 112, a 3D body movement of the respective users 110, 112, a haptic control of the respective users 110, 112, a spatial proximity of the avatars 114, 116 with respect to one or more rendered objects associated with the XR application 103, a 3D object pose of one or more rendered objects associated with the XR application 103.

In particular embodiments, as previously noted, the processor 150 may include the user layer 152. The user layer 152 may include any software layer or software system (e.g., user interfaces (UIs), graphical user interfaces (GUIs), buttons, menus, text boxes, widgets, objects, event handlers, macros, scripts, and so forth) suitable for receiving and processing interactions and/or inputs of the user 110. In particular embodiments, the application layer 154 may include any software layer, middleware layer, or software or middleware system suitable for servicing and processing communications, data transfers, network protocols, and authentication and authorization data between any number of XR applications 103 executing within the XR environment 102 as executed by the XR device 104.

The XR service layer 156 may include any software layer, middleware layer, or software or middleware system (e.g., operating system, edge operating system, and so forth) suitable for hosting and servicing the XR environment 102 as executed by the XR devices 104, 106. For example, in one embodiment, the XR service layer 156 may include one or more of a Platform as a Service (PaaS) layer, a Software as a Service (SaaS) layer, an Infrastructure as a Service (IaaS) layer, a Compute as a Service (CaaS) layer, a Data as a Service (DaaS) layer, a Database as a Service (DBaaS) layer, or other similar cloud-based computing architecture (e.g., “X” as a Service (XaaS)) suitable for hosting and servicing the XR environment 102.

The XR service layer 156 may also be suitable for performing one or more machine-learning based algorithms. For example, the XR service layer 156 may be configured to identify the users 110, 112 using any suitable face-tracking algorithm, eye-tracking algorithm, gesture recognition algorithm, and so forth. In one embodiment, the XR service layer 156 identifies the users 110, 112 by searching for each users' 110 image in the users' profile 162 in memory 160, and for each of the users 110, 112, matching users' 110, 112 image to one of the stored user's profiles 164. In particular embodiments, the users' profile 162 in memory 160 includes users' authority level 166 that indicates which content 174 containing sensitive information, the user 110, 112 are authorized to view.

For example, a first viewer among users 110, 112 with a low authority level 166 is authorized to view content 174 with a low sensitivity level 176. A second viewer among users 110, 112 with a high authority level 166 is authorized to view content 174 with low to high sensitivity levels 176. The authority level 166 of each of the users 110, 112 may be stored in their respective user's profile 164. Once the XR service layer 156 determines the identity of users 110, 112, the XR service layer 156 searches the users' profile 162 and matches the users 110, 112 image to one of the user's profiles 162.

The proximity threshold dataset 178 may also include tables for different content 174, different item sensitivity levels 176, different XR device 106 and/or second user avatar 116 virtual locations, and/or the like. For example, a first table may include distances from XR device 106 and/or second user avatar 116, from which the same image with different virtual locations is identifiable. A second table may include distances from XR device 106 and/or second user avatar 116, from which the same text with different font virtual locations is identifiable. A third table may include distances from XR device 106 and/or second user avatar 116, from which the same image with the same virtual location but different resolutions is identifiable. A fourth table may include distances from the XR device 106 and/or second user avatar 116 with different virtual locations, from which the same image is identifiable. Then, based on these data points, a proximity threshold 117 for content 174 that has the same or closest data point to a particular datapoint may be determined.

### Generating and Transmitting Single-Use Tokens Based on Multidimensional Captures of Digital Signatures

Embodiments of the present disclosure discuss techniques system for generating and transmitting single-use tokens based on multidimensional captures of digital signature gestures.

FIG. 2 is an embodiment of a workflow diagram 200 for generating and transmitting single-use tokens based on multidimensional captures of digital signature gestures, in accordance with certain aspects of the present disclosure. In one embodiment, the workflow diagram 200 may be performed solely by the XR system 140 as discussed above with respect to FIG. 1. In another embodiment, the workflow diagram 200 may be performed by the XR system 140 in conjunction with the XR device 104. For example, in one embodiment, the XR device 104 may be utilized to capture a unique digital signature gesture performed by the user 110 in 3D physical space via one or more LiDAR sensors or depth camera sensors included as part of the XR device 104. In such an embodiment, the processing of the captured unique digital signature gesture and the generation of a single-use interaction token based thereon may be then performed by the XR system 140. In yet another embodiment, the workflow diagram 200 may be performed by executing a series of “handshakes” and distributed tasks between the XR system 140 and the XR device 104.

As depicted by FIG. 2, the workflow diagram 200 may begin with the XR device 104 capturing (at functional block 202) a unique gesture performed by the user 110 in 3D physical space. For example, in one embodiment, in response to the user 110 attempting to perform a particular interaction with the XR application 103, the user 110 may be then prompted (at functional block 204) to perform a unique hand gesture, a unique hand pose, a unique head pose, a unique body movement, or other similar unique digital signature gesture that may be captured by a LiDAR sensor or one or more depth cameras of the XR device 104. In particular embodiments, the LiDAR sensor of the XR device 104 may radiate beams of light into the 3D physical space in which the user 110 is performing the unique digital signature gesture and capture a number of data points of reflected light. The number of data points of reflected light may be then utilized by the XR device 104 to calculate a 3D XYZ coordinate position for each data point to produce a set of 3D coordinate measurements corresponding to the performed unique gesture.

In particular embodiments, the workflow diagram 200 may then continue with the XR system 140 (at functional block 206) generating a 3D point cloud by processing the 3D coordinate measurements. For example, the 3D point cloud may include a detailed 3D rendering of the unique digital signature gesture performed by the user 110. In particular embodiments, the workflow diagram 200 may then continue with the XR system 140 generating (at token generation model functional component 208) a single-use interaction token for the user 110 based on the 3D point cloud representative of the unique digital signature gesture performed by the user 110. In particular embodiments, the workflow diagram 200 may then continue with the XR system 140 verifying (at decision functional component 210) that the single-use interaction token for the user 110 has been generated.

In particular embodiments, upon the XR system 140 verifying that the single-use interaction token for the user 110 has been generated, the XR system 140 may then provide the single-use interaction token to the XR device 104. Specifically, the XR system 140 may generate the single-use interaction token to allow the user 110 to perform the particular interaction with the XR application 103. For example, to perform the particular interaction with the XR application 103, the workflow diagram 200 may then continue with the XR device 104 modulating (at functional blocks 212 and 214) the single-use interaction token into optical bits utilizing a radiant crystal waveguide on the XR device 104. In one embodiment, the radiant crystal waveguide may include any high-performance waveguide material suitable for storing and transmitting optically-encoded information with high precision and reliability.

The workflow diagram 200 may then continue with the XR device 104 utilizing (at functional block 216) steganography and wavelength division multiplexing (WDM) based fiber optical communications to transmit in a secure manner the generated single-use interaction token to the XR system 140 for unique authentication of the user 110 prior to finalizing the particular interaction with the XR application 103. For example, WDM may include optical fiber transmission suitable for allowing multiple signals to be transmitted over a single fiber optic cable by using different wavelengths (e.g., colors) of light. Specifically, by leveraging WDM based fiber optical communications, the workflow diagram 200 may continue with the XR device 104 transmitting (at functional block 218) the generated single-use interaction token concealed in the optical rays utilizing a steganography encryption process. The steganography encryption process may ensure that the XR system 140 receives (at functional block 220) the generated single-use interaction token unmodified and untampered.

In particular embodiments, upon the XR system 140 receiving the WDM based fiber optical transmission from the XR device 104, the XR system 140 may then extract the unique digital signature gesture of the user 110 from the WDM based fiber optical transmission onto which the generated single-use interaction token was previously modulated. The workflow diagram 200 may then continue with the XR system 140 verifying and validating (at functional block 224) the authenticity of the generated single-use interaction token. In one embodiment, the XR system 140 may verify and validate the generated single-use interaction token by comparing the extracted unique digital signature gesture to a unique digital signature gesture of the user 110 stored on the XR system 140.

In another embodiment, the XR system 140 may verify and validate the generated single-use interaction token by confirming that the generated single-use interaction token has not expired (e.g., has not been active or stored for more than 5 minutes, more than 3 minutes, or more than 1 minute), has not been used once before, has not been modified, has not been associated with another user 112 (e.g., as opposed to the user 110), or is not being utilized outside of an authorized location within the XR environment 102. In particular embodiments, in response to the XR system 140 determining (at decision functional component 226) that the generated single-use interaction token is invalid, the workflow diagram 200 may continue with the XR system 140 reporting (at functional block 228) that the generated single-use interaction token is invalid to a system administrator associated with the XR system 140.

In particular embodiments, in response to the XR system 140 determining (at decision functional component 226) that the generated single-use interaction token is valid, the workflow diagram 200 may continue with the XR system 140 decrypting (at functional block 230) user data relating to the particular interaction with the XR application 103 to be finalized. The workflow diagram 200 may then continue with the XR system 140 finalizing (at functional block 232) the particular interaction with the XR application 103 based on the decrypted user data relating to the particular interaction with the XR application 103. For example, in one embodiment, finalizing the particular interaction with the XR application 103 may include causing the XR application 103 to execute a predetermined action desired by the user 110. The workflow diagram 200 may then conclude with the XR system 140 updating (at functional block 234) any relevant databases (e.g., users' profile 162 or first user's profile 164) or other systems on the XR system 140 with a record of the particular interaction with the XR application 103 and/or the executed predetermined action.

Thus, in accordance with the presently disclosed embodiments, the XR system 140 may receive from one or more LiDAR sensors of the XR device 104 a capture of a unique digital signature gesture of a user 110 performed in 3D physical space. For example, the user 110 may perform the unique digital signature gesture in 3D space while viewing the XR environment 102 executing on the XR device 104. The XR system 140 may then convert the LiDAR sensor capture of the unique digital signature gesture into a 3D point cloud, which may represent a feature vector of the unique digital signature gesture of the user 110 in 3D space.

The XR system 140 may then utilize the feature vector to generate a single-use interaction token for the user 110 to execute a specific interaction with the XR application 103 executing within the XR environment 102. For example, in one embodiment, the XR system 140 may generate the single-use interaction token for the user 110 to finalize an execution of a sequence of user interactions with the XR application 103 executing within the XR environment 102. In one embodiment, the generated single-use interaction token may include an encryption of the unique digital signature gesture to be utilized to finalize the execution of the sequence of user interactions with the XR application 103. Upon completion of the execution of the sequence of user interactions with the XR application 103, the XR system 140 may then destroy the single-use interaction token.

Accordingly, the disclosed system and methods improve XR systems 140 by providing a 3D token-based authentication process specifically suited for XR environments 102 to secure sensitive data and user interactions exchanged and/or executed within XR environments 102. Specifically, in response to the user 110 attempting to finalize the execution of a sequence of user interactions with the XR application 103 executing within the XR environment 102, the user 110 is prompted to perform a unique digital signature gesture. The unique digital signature gesture is converted to a 3D point cloud and utilized to generate a unique single-use interaction token for the user 110. The user 110 is then allowed to finalize the execution of the sequence of user interactions with the XR application 103 based on the unique single-use interaction token, which is subsequently destroyed.

In this way, the disclosed system and methods further improve XR environments 102 and data transmission security associated with XR environments 102, as the unique single-use interaction token is an encrypted and use-and-destroy 3D digital token incapable of being replicated, modified, reused, or stored for more than a few minutes (e.g., less than 5 minutes, less than 3 minutes, or less than 1 minute). Additionally, the 3D nature of the unique single-use interaction token provides a further layer of security by leveraging the uniqueness of each individual user 110 and the various hand, head, and body poses performable by the individual user 110 in 3D physical space.

FIG. 3 illustrates a flowchart of an example method 300 for generating and transmitting single-use tokens based on multidimensional captures of digital signature gestures, in accordance with one or more embodiments of the present disclosure. The method 300 may be performed by the system and network 100 as described above with respect to FIG. 1. The method 300 may begin at block 302 with the XR system 140 rendering on one or more displays of an XR device 104 an extended reality (XR) environment 102. For example, in one embodiment, the XR environment 102 may include any XR environment (e.g., VR environment, AR environment, MR environment, and so forth) suitable for facilitating user 110 interactions with the XR application 103 while executing within the XR environment 102.

The method 300 may continue at block 304 with the XR system 140 detecting, based on sensor data obtained from one or more sensors of the XR device 104, a user gesture performed in 3D space. For example, the detected user gesture may include a 3D point cloud representative of one or more user 110 interactions performed in 3D space. In particular embodiments, the one or more sensors of the XR device 104 may include one or more LiDAR sensors or one or more depth cameras suitable for capturing a number of points utilized to generate a 3D point cloud of a hand, head, or body gesture or pose performed by the user 110 in 3D physical space.

The method 300 may continue at block 306 with the XR system 140 determining, based on the detected user gesture, a unique digital signature of the user in 3D space. The method 300 may continue at block 308 with the XR system 140 generating, based on the unique digital signature of the user, a single-use interaction token for finalizing an execution of a sequence of user interactions with at least one XR application. For example, in one embodiment, the single-use interaction token may include a unique single-use interaction token encrypted with the unique digital signature of the user 110 utilizing a 3D discrete wavelet transform (DWT).

In particular embodiments, the method 300 may continue at decision 310 with the XR system 140 confirming whether the single-use interaction token has been generated. In particular embodiments, in response to the XR system 140 determining that the single-use interaction token has not been generated, the method 300 may return to the block 308 at which the single-use interaction token may be generated based on the unique digital signature of the user. On the other hand, in response to the XR system 140 determining that the single-use interaction token has been generated, the method 300 may continue at decision 312 with the XR system 140 determining whether the generated single-use interaction token is valid.

For example, in particular embodiments, the XR system 140 may determine that the generated single-use interaction token is valid by determining that the generated single-use interaction token has not expired (e.g., has not been active or stored for more than 5 minutes, more than 3 minutes, or more than 1 minute), has not been used once before, has not been modified, has not been associated with another user 112 (e.g., as opposed to the user 110), or is not being utilized outside of an authorized location within the XR environment 102. In particular embodiments, in response to the XR system 140 determining (e.g., at decision 312) that the single-use interaction token is not valid (e.g., invalid), the method 300 may reject finalizing the execution of the sequence of user interactions with the at least one XR application 103 and end the method 300.

On the other hand, in response to the XR system 140 determining (e.g., at decision 312) that the single-use interaction token is valid, the method 300 may continue at block 314 with the XR system 140 finalizing the execution of the sequence of user interactions with the with the at least one XR application based on the single-use interaction token. For example, in one embodiment, the XR system 140 may finalize the execution of the sequence of user interactions with the XR application 103 to execute a predetermined action. In accordance with the presently disclosed embodiments, upon completion of the execution of the sequence of user 110 interactions with the XR application 103, the XR system 140 may then destroy the single-use interaction token.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system, comprising:
a memory configured to store image data utilized to render an extended reality (XR) environment on an XR device associated with a user and a plurality of XR applications executable within the XR environment; and
one or more processors operably coupled to the memory and configured to:
render, on one or more displays of the XR device, the XR environment, wherein the XR environment is configured to facilitate user interactions with the plurality of XR applications while executing within the XR environment;
detect, based on sensor data obtained from one or more sensors of the XR device, a user gesture performed in three-dimensional (3D) space, wherein the detected user gesture comprises a point cloud representative of one or more user interactions performed in 3D space;
determine, based on the detected user gesture, a unique digital signature of the user in 3D space;
generate, based on the unique digital signature of the user, a single-use interaction token for finalizing an execution of a sequence of user interactions with at least one of the plurality of XR applications; and
finalize the execution of the sequence of user interactions with the at least one of the plurality of XR applications based on the single-use interaction token.

2. The system of claim 1, wherein the one or more sensors of the XR device comprises one or more Light Detection and Ranging (LiDAR) sensors or one or more depth cameras.

3. The system of claim 1, wherein the one or more processors are further configured to encrypt the single-use interaction token with the unique digital signature of the user utilizing a 3D discrete wavelet transform (DWT).

4. The system of claim 1, wherein the single-use interaction token is configured to be modulated into a plurality of optical bits utilizing a radiant crystal waveguide.

5. The system of claim 4, wherein the plurality of optical bits is configured to be transmitted utilizing steganography and wavelength division multiplexing (WDM) based fiber optical communication.

6. The system of claim 1, wherein the one or more processors are further configured to finalize the execution of the sequence of user interactions with the at least one of the plurality of XR applications to execute a predetermined action.

7. The system of claim 1, wherein the one or more processors are further configured to destroy the single-use interaction token subsequent to the execution of the sequence of user interactions with the at least one of the plurality of XR applications.

8. A method, comprising:
rendering, on one or more displays of an extended reality (XR) device, an XR environment, wherein the XR environment is configured to facilitate user interactions with a plurality of XR applications while executing within the XR environment;
detecting, based on sensor data obtained from one or more sensors of the XR device, a user gesture performed in three-dimensional (3D) space, wherein the detected user gesture comprises a point cloud representative of one or more user interactions performed in 3D space;
determining, based on the detected user gesture, a unique digital signature of the user in 3D space;
generating, based on the unique digital signature of the user, a single-use interaction token for finalizing an execution of a sequence of user interactions with at least one of the plurality of XR applications; and
finalizing the execution of the sequence of user interactions with the at least one of the plurality of XR applications based on the single-use interaction token.

9. The method of claim 8, wherein the one or more sensors of the XR device comprises one or more Light Detection and Ranging (LiDAR) sensors or one or more depth cameras.

10. The method of claim 8, further comprising encrypting the single-use interaction token with the unique digital signature of the user utilizing a 3D discrete wavelet transform (DWT).

11. The method of claim 8, wherein the single-use interaction token is configured to be modulated into a plurality of optical bits utilizing a radiant crystal waveguide.

12. The method of claim 11, wherein the plurality of optical bits is configured to be transmitted utilizing steganography and wavelength division multiplexing (WDM) based fiber optical communication.

13. The method of claim 8, wherein finalizing the execution of the sequence of user interactions comprises causing the at least one XR application to execute a predetermined action.

14. The method of claim 8, further comprising destroying the single-use interaction token subsequent to the execution of the sequence of user interactions with the at least one of the plurality of XR applications.

15. A non-transitory computer-readable medium storing instructions that, when executed by one or more processors, cause the one or more processors to:
render, on one or more displays of an extended reality (XR) device, an XR environment, wherein the XR environment is configured to facilitate user interactions with a plurality of XR applications while executing within the XR environment;
detect, based on sensor data obtained from one or more sensors of the XR device, a user gesture performed in three-dimensional (3D) space, wherein the detected user gesture comprises a point cloud representative of one or more user interactions performed in 3D space;
determine, based on the detected user gesture, a unique digital signature of the user in 3D space;
generate, based on the unique digital signature of the user, a single-use interaction token for finalizing an execution of a sequence of user interactions with at least one of the plurality of XR applications; and
finalize the execution of the sequence of user interactions with the at least one of the plurality of XR applications based on the single-use interaction token.

16. The non-transitory computer-readable medium of claim 15, wherein the one or more sensors of the XR device comprises one or more Light Detection and Ranging (LiDAR) sensors or one or more depth cameras.

17. The non-transitory computer-readable medium of claim 15, wherein the instructions further cause the one or more processors to encrypt the single-use interaction token with the unique digital signature of the user utilizing a 3D discrete wavelet transform (DWT).

18. The non-transitory computer-readable medium of claim 15, wherein the single-use interaction token is configured to be modulated into a plurality of optical bits utilizing a radiant crystal waveguide.

19. The non-transitory computer-readable medium of claim 18, wherein the plurality of optical bits is configured to be transmitted utilizing steganography and wavelength division multiplexing (WDM) based fiber optical communication.

20. The non-transitory computer-readable medium of claim 15, wherein the instructions further cause the one or more processors to destroy the single-use interaction token subsequent to the execution of the sequence of user interactions with the at least one of the plurality of XR applications.
